(19) United States
(12) Patent Application Publication
(10) Pub. No.: US 2005/0019532 A1
(43) Pub. Date: Jan. 27, 2005

(54) Filler for architectural panel joints and tool

(76) Inventors: David R. Hall, Provo, UT (US); Joe Fox, Sp. Fork, UT (US)

Correspondence Address: David R. Hall, 2185 S. Larsen Pkwy, Provo, UT, 84606, US

(21) Appl. No.: 10/918,591

(22) Filed: Aug. 16, 2004

Related U.S. Application Data
(62) Division of application No. 10/453,287, filed on Jun. 3, 2003.

(51) Int. Cl. B32B 7/12

(52) U.S. Cl. 428/195.1; 428/343

(57) ABSTRACT

A filler for finishing architectural panel joints comprising masticized tape having a preferential distribution of mastic along its working surface. The preferential distribution of mastic facilitates finishing of the architectural panel joints. The preferential distribution of mastic may comprise the formation of a non-planar layer of mastic on the tape. The distribution may further comprise a greater volume of mastic along the edge portions of the tape than in the center portion of the tape, or vice versa, or a greater portion in one region of the tape than in another region of the tape. A tool is also provided comprising a mechanism for dispensing masticized tape connected to a tool body. The mechanism comprises a flow valve having a working surface suitable for preferential distribution of the mastic onto the tape. The mechanism further comprises mastic shrouds for containing the flow of mastic and a sprocket cap.

### RELATED INVENTIONS

A divisional application Ser. No. of 10/453,287, filed Jun. 03, 2003.

### BACKGROUND OF THE INVENTION

This invention relates to a filler for finishing architectural panel joints. More particularly this invention relates to masticized tape having a preferential distribution of mastic disposed thereon. Additionally, this invention relates to a tool comprising a flow valve for preferential distribution of mastic onto the tape. The tool further comprises features that facilitate filling and reduce the potential for damage to the panels being finished.

The investigator is referred to the following U.S. references, and the references cited therein, as examples of the art relative to the tools of the present invention.

U.S. Pat. No. 4,208,239, to Lass, incorporated herein by this reference, teaches a tubular main body having a circular shape that is held by the operator. At one end of the body, a tape applicator head is provided and is supplied with tape cement from a remote supply under pressure. A supply roll of tape is fed through the applicator head onto the wall joint to be taped. In the applicator head, a pair of tape drive wheels engage the tape and press it against the wall for taping a seam. As the drive wheels pull the tape through the applicator head, dry wall cement is applied to the tape in an even layer. A flexible wiper blade carried from the head presses the tape into engagement with the wall.

U.S. Pat. No. 5,535,926, to Blitz, incorporated herein by reference, discloses an apparatus for applying mastic to a selected surface and includes a container for mastic, a pump assembly, and a drywall tool or wand. The wand is intended to apply a uniform layer of mastic filler to the panel joint. The drywall tool has circular body that is held by the operator handling the tool. The pump is operated by an air compressor. The apparatus is mounted on a hand truck so that it may be removed to different locations.

U.S. Pat. No. 6,513,562, to Trout, incorporated herein by this reference, provides a unitary nozzle adjacent to a tubular body having a circular shape. The unitary design of the nozzle allows for the application of a cutter mechanism, wheels to provide motive force, and a mastic tube to supply mastic to the fill section. Here again, the mastic is evenly distributed across the surface of the tape as it exits the nozzle.

U.S. Pat. No. 4,828,647, to Eccleston, incorporated herein by this reference, discloses an apparatus having a tubular housing which holds a supply of mastic. The tubular housing has a circular form and is attached to a main drive roller mounted at the forward end of the housing which rotates by friction as it is moved along a wall and tape drive roller means operated by the main drive roller and which feeds the tape forwardly. The cover plate depicted in FIG. 1 of the specification, exhibits a protruding edge for directing the flow of mastic in uniform even distribution onto the tape. See item 5, FIG. 3, of reference '121, below.

U.S. Pat. No. 4,652,331, to Plasencia, incorporated herein by this reference, reveals a tape and adhesive applicator for dry wall taping that has an adhesive dispensing nozzle adapted to be mounted on a caulking gun and a applicator roll mounted adjacent the outlet of the nozzle. The body of the caulking gun receives a tubular supply of mastic and both the tubular supply and the body of the gun have a circular form. The loaded caulking gun is attached to the adhesive applicator which has a form similar to a four sided polygon. Here, again the flow of mastic onto the tape is intended to provide a uniform layer.

U.S. Pat. No. 4,086,121, to Ames, incorporated herein by this reference, discloses a self-contained dry wall taper that has a hollow elongated body for holding mastic and supports a roll of tape with tape feeding means to deliver the tape applying wheels that in turn apply it to cover a joint. The applicator comprises a tape creasing disc that can be swung into operative position by the operator for providing a median crease along the length of the tape and for forcing the crease into the room corner. The elongated body has a circular form. The dispensing mechanism of this specification comprises a protruding edge 5, depicted in FIG. 3, to promote an even distribution of the mastic onto the tape.

Further reference is made to U.S. Pat. No. 2,815,142, to Ames, and U.S. Pat. No. 3,260,638, to Hoveland, incorporated herein by this reference, depicting tools relevant to this application having tubular bodies with a circular form and providing for a uniform distribution of the mastic material onto the tape.

In the art, mastic is applied in a generally uniform and even distribution onto tape. The applicants have found that by altering the disposition of the mastic onto the tape in preferential manner, more efficient finishing of architectural panel joints may be achieved. Therefore, what is needed is a tool comprising a flow valve having a working surface that allows for a preferential distribution of mastic onto the tape.

### SUMMARY OF THE INVENTION

A long standing need is manifest in applying a filler in the joints between architectural panels. Over the years, many solutions have been proposed. Modernly, the most common method is in the use of masticized tape. The invention proposed in this disclosure presents a filler for finishing architectural panel joints comprising masticized tape having a non-planar preferential distribution of mastic along its working surface. The non-planar preferential distribution of mastic facilitates finishing of the architectural panel joints by controlling the volume of mastic in such a manner that the time required for finishing the joint is decreased. The non-planar preferential distribution of mastic provided herein may comprise a variety of distribution schemes as required by those who are experts in the field of finishing panel joints. Furthermore, the preferential distribution of mastic provided herein allows designers and engineers to specify means and methods for finishing panel joints with greater precision, thereby reducing the costs and time required to finish construction. All the schemes are intended to place a controlled volume of mastic in relation to the joint being finished in order to reduce waste and the number of applications of mastic to the joint. In most commercial architectural projects, the filler is applied to the panel joints using a tool designed for such purpose. The tool is designed to apply the mastic to the tape in an even layer and, in some cases, the volume of mastic on the tape is entirely at discretion of the technician operating the tool. The non-planar preferential distribution of mastic as provided herein allows for the formation of a non-planar layer of mastic on the tape. The distribution may further comprise a greater volume of mastic along the edge portions of the tape than in the center portion of the tape, or vice versa, or a greater portion in one region of the tape than in another region of the tape. A tool is also provided comprising a mechanism for dispensing masticized tape connected to a tool body. The mechanism comprises a flow valve having a working surface suitable for preferential distribution of the mastic onto the tape. The flow valve may be an appendage to the tool, or it may be integral to a tool member. The mechanism further comprises mastic shrouds for containing the flow of mastic and a sprocket cap. The sprocket cap protects the architectural panels and previously filled joints from damage, especially in restricted areas such as in tight corners.

### BRIEF DESCRIPTION OF THE DRAWINGS

FIG. 1 is a perspective diagram of tool for dispensing masticized tape comprising a flow valve for preferential distribution of mastic onto the tape.

FIG. 2 consists of four cross-sectional diagrams exemplary of the preferential distribution of mastic onto the tape.

### DETAILED DESCRIPTION OF THE INVENTION

Modern construction technology has provided a variety of materials for architectural panels. These materials included sheet rock, wall board, gypsum board, foam board, stucco, wafer board, plywood, decorative paneling, particle board, or composite board, and some designs may require a combination of these materials. These panels are generally mechanically or adhesively attached adjacent to one another onto underlying building components. Regardless of the manner of attachment, the adjacent panels form either an open or closed joint. It is desirable in most cases to finish the panel joints by applying a filler to the joint and feathering the joint so that when paint is applied to the panels the joints are less apparent.

A long standing need is manifest in applying the filler in finishing the joints between architectural panels. Over the years, many solutions have been proposed. Modernly, the most common method is in the use of masticized tape. In the background of this specification reference has been made to relevant U.S. patents as examples of the technology that has developed for applying masticized tape to architectural panels. The foregoing references are incorporated herein. The investigator is directed to said references for the details concerning the mechanisms and materials that have developed over the years, and for further specification of the elements of this invention.

The invention proposed in this disclosure advances the present technology by providing a filler for finishing architectural panel joints comprising masticized tape having a non-planar preferential distribution of mastic along its working surface. Any suitable architectural tape comprising an elongate flexible, natural or synthetic, solid or mesh material selected from the group consisting of fabric, paper, metal, and plastic, or a combination thereof may be used in this invention. Additionally, any suitable mastic selected from the group consisting a formulation of mud, or dry wall mud, known in the art may be applied according to the disclosure herein. The non-planar preferential distribution of mastic facilitates finishing of the architectural panel joints by controlling the volume of mastic in such a manner that the time required for finishing the joint is decreased.

The non-planar preferential distribution of mastic provided herein may comprise a variety of distribution schemes as required by those who are experts in the field of finishing panel joints. Furthermore, the non-planar preferential distribution of mastic provided herein allows designers and engineers to specify means and methods for finishing panel joints with greater precision, thereby reducing the costs and time required to finish construction. All the schemes are intended to place a controlled volume of mastic in relation to the joint being finished in order to reduce waste and the number of applications of mastic to the joint.

In most commercial architectural projects, the filler is applied to the panel joints using a tool designed for such purpose. The tool is designed to apply the mastic to the tape in an even layer and, in some cases, the volume of mastic on the tape is entirely at discretion of the technician operating the tool. The non-planar preferential distribution of mastic as provided herein allows for the formation of a non-planar layer of mastic on the tape. The distribution may further comprise a greater volume of mastic along the edge portions of the tape than in the center portion of the tape, or vice versa, or a greater portion in one region of the tape than in another region of the tape.

The tool provided herein incorporates many useful features known in the art as disclosed in the foregoing references. The tool herein advances the art by providing a non-planar flow valve having a working surface suitable for preferential distribution of the mastic onto the tape. The flow valve may be an appendage to the tool, or it may be integral to a tool member. The tool further advances the art by providing mastic shrouds for containing the flow of mastic, and by providing a sprocket cap. The sprocket cap protects the architectural panels and previously filled joints from damage, especially in restricted areas such as in tight corners.

The invention will be further described in relation to the drawing figures. These figures are for illustration only and doubtless those skilled in the art will recognize further applications. Such further applications are intended to be included within the scope of this disclosure.

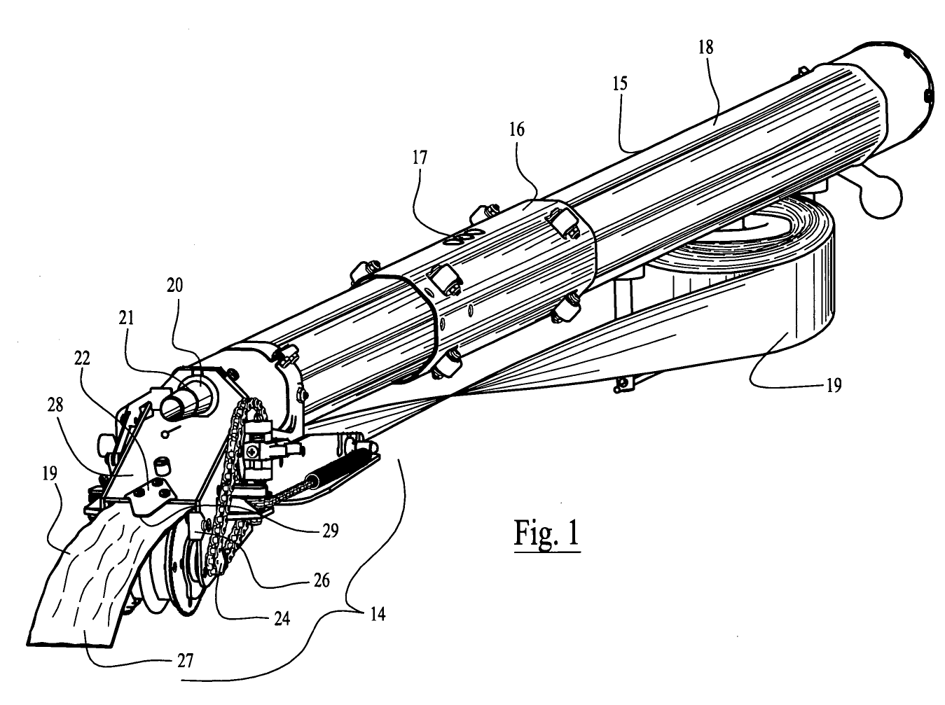

FIG. 1 is a perspective diagram of tool for dispensing masticized tape comprising a flow valve for preferential distribution of mastic onto the tape. The tool comprises a tubular tool body 15. In most cases, the tool body is used to store and dispense mastic to the head mechanism, or nozzle, 14. The outside of the tubular body may be circular or non-circular in cross section. Preferably, the tool body comprises a regular polygon having a least 6 planar surfaces 18. The polygonal shape promotes handling of the tube especially when the surface is slippery. It may be desirable for the tube to have a polygonal exterior surface and a circular interior surface. The body also comprises a slide mechanism 16 for actuating dispensing head mechanism 14. The slide mechanism features surface discontinuities 17 that are sensible to the sight and touch. The discontinuities provide a sensible means for orienting the tool without having the look away from the joint being finished. Further, the tool body comprises a supply of architectural tape 19 deposed on a roller mechanism and fed into the dispensing mechanism 14.

The dispensing mechanism 14 comprises a frame comprising sidewalls and a cover plate, brackets, wheels, ratchets, sprockets, springs, pawls, levers, tubes, wires, rollers, chains, scrapers, a blade, and fasteners as known in the art. Furthermore, the dispensing mechanism comprises a flow valve 22 that may be useful for preferential distribution of the mastic onto the tape. Once the mastic layer is preferentially applied to the tape 27, the combination of mastic and tape become a suitable filler for architectural panel joints. As depicted, flow valve 22 is an appendage to the dispensing mechanism 14. The valve is removably attached to the cover plate 28. The working surface of the valve 29 extends beyond to the edge of the cover plate 28 and intersects the masticized tape as it exits the dispensing mechanism. The working surface 29 of the valve 28 defines the preferential distribution of the mastic onto the tape. By altering the working surface of the valve, the preferential distribution of the mastic onto the tape may be further defined. In some embodiments of this invention, the flow valve may be integral to a member of the dispensing mechanism. For example, the leading edge of the cover plate may be modified to present a working surface suitable for preferential distribution of the mastic onto the tape. An advantage of the appendage valve configuration 22, as shown herein, aids in preventing the filler from flipping back over the dispensing mechanism during initial activation of the dispensing mechanism.

The dispensing mechanism 14 of the present invention further comprises mastic shrouds 26. The shrouds 26 promote containment of the mastic as it exits the dispensing mechanism. It is desirable that the shrouds 26 be removable for cleaning and adjustment. Also, the size and shape of the shrouds may be altered to meet the field requirements.

The dispensing mechanism 14 further comprises a sprocket cap 24. The applicants have discovered that the exposed location of the sprocket in the dispensing mechanism 14 often causes damage to the panels and previously filled joints in restricted areas such as tight corners. By adding the cover cap 24 the tendency for the tool to cause damage has been reduced and eliminated in most cases.

The dispensing mechanism 14 further comprises a fill nozzle 20. The fill nozzle 20 comprises a truncated, conical tube having a seal 21. The seal 21 may be an O-ring. In the industry, the various tool manufacturers of the tools depicted in FIG. 1 tend to use a fill nozzle specific for their own devices for filling the tool body with mastic. The applicants believe that the conical design of the fill nozzle 20, of the present invention, provides a universal nozzle that is suitable for use with a variety of tools from different tool manufacturers.

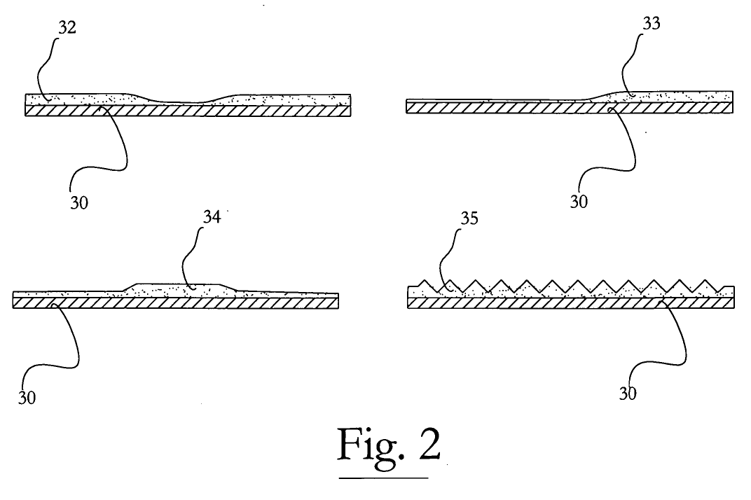

FIG. 2 consists of four cross-sectional diagrams exemplary of the non-planar preferential distribution of mastic onto the tape. These diagrams are for illustration only and do not constitute the many possible configurations that may be useful in the art. In FIG. 2, architectural tape 30 is depicted as having a non-planar layer of mastic 32, 33, 34, and 35 preferentially distributed thereon. Non-planar layer 32 provides a greater volume of mastic along the edges of the working surface of the tape. Non-planar layer 33 provides a greater volume of mastic in one region of the tape as opposed to another region of the working surface of the tape. Non-planar layer 34 provides for a layer of mastic in the center portion of the working surface of the tape. And non-planar layer 35 provides for a non-planar layer of mastic across the working surface of the tape. It may be desirable that the certain distributions be combined to facilitate the finishing of certain architectural panel joints. The non-planar preferential distribution allows for more efficient application of the filler to the panel joints, thereby reducing waste, application time, and costs.

1. A filler for finishing architectural panel joints comprising masticized tape, wherein the mastic is preferentially distributed in a non-planar configuration onto the tape prior to the application of the filler to the panel joints.

2. The filler of claim 1, wherein said filler is suitable for finishing architectural panel joints formed by adjacent panels of sheet rock, wall board, gypsum board, wafer board, plywood, decorative paneling, particle board, or composite board, or a combination thereof.

3. The filler of claim 1, wherein the tape comprises an elongate flexible, natural or synthetic, solid or mesh material selected from the group consisting of fabric, paper, metal, and plastic, or a combination thereof.

4. The filler of claim 1, wherein the mastic comprises a material selected from the group consisting of natural or synthetic mud, drywall mud, and cement, or a combination thereof.

5. The filler of claim 1, wherein the tape has a non-planar preferential distribution of mastic along its working surface.

6. The filler of claim 1, wherein the non-planar distribution of mastic is preferentially in greater volume along the edge portions of the working surface of the tape than in the center portion of the tape.

7. The filler of claim 1, wherein the non-planar distribution of mastic is preferentially in greater volume in the central region of the working surface of the tape than along the edges.

8. The filler of claim 1, wherein the non-planar distribution of mastic is preferentially in greater volume along one portion of the working surface of the tape than along another portion of the tape.
